(19) United States
(12) Patent Application Publication
(10) Pub. No.: US 2011/0176006 A1
(43) Pub. Date: Jul. 21, 2011

(54) VIDEO MONITORING SYSTEM AND METHOD

(75) Inventor: CHAO-TSUNG FAN, Tu-Cheng (TW)

(73) Assignee: HON HAI PRECISION INDUSTRY CO., LTD., Tu-Cheng (TW)

(21) Appl. No.: 12/720,846

(22) Filed: Mar. 10, 2010

(30) Foreign Application Priority Data
Jan. 21, 2010 (TW) 99101562

(51) Int. Cl. H04N 7/18

(52) U.S. Cl. 348/153; 348/E07.085

(57) ABSTRACT

A processing unit receives information of the intruder from a detection unit and compares the received information with the camera database stored in a storage unit, to determine a next monitored area that the intruder will enter. If the intruder remains in the current monitored area, the processing unit controls the camera of the current monitored area to capture the images of the intruder and sends the images to the detection unit. If the intruder enters an intersection area of the current monitored area and the next monitored area, the processing unit obtains the camera of the current monitored area and a camera corresponding to the next monitored area from the camera database and controls the cameras of the current monitored area and the next monitored area to capture the images of the corresponding monitored areas and sends the images to the detection unit.

### BACKGROUND

1. Technical Field

The present disclosure relates to a video monitoring system and a video monitoring method.

2. Description of Related Art

Video monitoring systems monitor areas by cameras positioned in the areas to be monitored. The security-monitoring terminal can monitor captured images through monitor screens. To locate an intruder in a supervised area, the user of the security-monitoring terminal needs to switch the camera manually, to continuously track the intruder, which is inconvenient.

### BRIEF DESCRIPTION OF THE DRAWINGS

FIG. 1 is a block diagram of an embodiment of a video monitoring system.

FIG. 2 is a schematic diagram of how the video monitoring system of FIG. 1 can monitor areas.

FIG. 3 is a flowchart of an embodiment of a video monitoring method.

### DETAILED DESCRIPTION

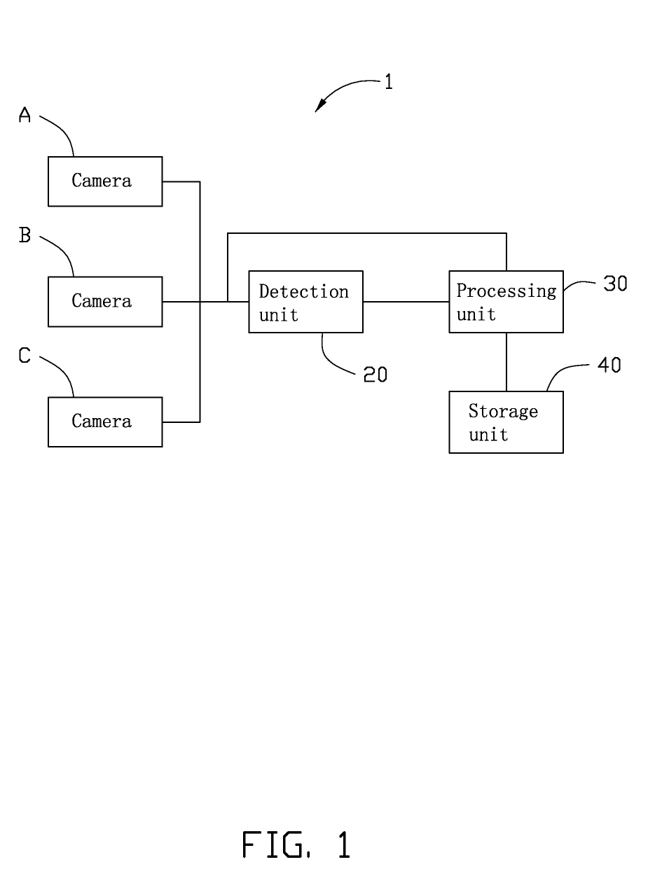

Referring to FIG. 1, an embodiment of a video monitoring system 1, includes a plurality of image capturing units, such as cameras, a detection unit 20, a processing unit 30, and a storage unit 40. In one embodiment, a plurality of units to capture images, includes three cameras A, B, and C. The cameras A, B, and C connect to the detection unit 20. The detection unit 20 connects to the processing unit 30. The processing unit 30 connects to the storage unit 40 and the cameras A, B, and C.

The cameras are mounted in a plurality of areas that need to be monitored, to capture images in an area and send the captured images to the detection unit 20.

The detection unit 20 can determine whether an intruder enters an area, according to the captured images from the cameras. When an intruder enters one of the areas, the detection unit 20 confirms a position of the intruder and other information according to the captured images and sends the position and other information to the processing unit 30. Other information may include face recognition of the intruder. In one embodiment, the detection unit 20 is a facial recognition unit. The detection unit 20 examines the images to find items, such as faces, in the captured images to determine whether there are intruders in the areas. It is noteworthy, that the detection unit 20 can use a well-known facial recognition technology to find faces in the images. Upon the condition that the detection unit 20 finds a face in the captured images during monitoring, it assesses that there might be an intruder entering one of the monitored areas.

The storage unit 40 stores a camera database. In one embodiment, the camera database can be described as shown in Table 1. The database includes the following parameters: camera of the current monitored area where the intruder enters, next monitored area the intruder will enter, and camera corresponding to the next monitored area. For example, the intruder is currently located in a first area “a” corresponding to camera A, and the next time the intruder may be located in a second area “b” monitored with camera B, or in a third area “c” monitored with camera C.

TABLE 1

| Camera of the | Next monitored | Camera corresponding |
|---|---|---|
| current monitored area | area the intruder | to the next |
| where the intruder enters | will enter | monitored area |
| A | c | C |
| A | b | B |
| A | a | A |
| A | ab | A and B |
| A | ac | A and C |
| A | abc | A, B and C |
| A | bc | B and C |

The processing unit 30 receives the position information of the intruder from the detection unit 20, and compares the received position information with the content of the database stored in the storage unit 40, to determine the next monitored area that the intruder will enter. If the intruder still remains in the current monitored area, the processing unit 30 controls the camera of the current monitored area to continuously capture images of the intruder, and sends the captured images to the detection unit 20. If the intruder enters an intersection between the current monitored area and the next monitored area, the processing unit 30 switches between the cameras of the current monitored area to the camera corresponding to the next monitored area. Then, it controls the cameras of the current monitored area and the next monitored area to capture the images of the corresponding monitored areas, and sends the captured images to the detection unit 20, thus automatically and continuously tracking the intruder. Therefore, there is no need to manually switch the cameras for capturing images.

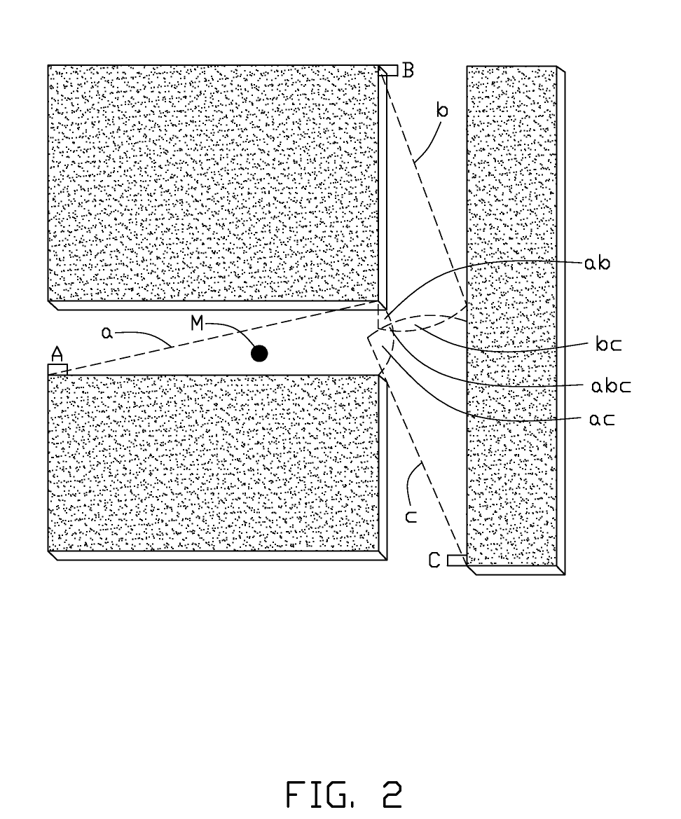

To illustrate one scenario, referring to FIG. 2, the camera A is set in the first area and has a triangle-shaped monitoring range bounded by dashed lines “a,” camera B is set in the second area and has a triangle-shaped monitoring range bounded by dashed lines “b,” and camera C is set in the third area and has a triangle-shaped monitoring range bounded by dashed lines “c.” An intersection “ab” is formed between the first monitoring range “a” and the second monitoring range “b.” An intersection “ac” is formed between the first monitoring range “a” and the third monitoring range “c.” An intersection “bc” is formed between the second monitoring range “b” and the third monitoring range “c.” An intersection “abc” is formed amongst the first to third monitoring ranges “a” to “c.” A black dot M, shown in FIG. 2, represents a current position of the intruder.

The camera A captures the image of the intruder if he/she enters the monitored area “a,” and sends the captured images to the detection unit 20. When the detection unit 20 confirms that the intruder entered the monitored area “a” according to the captured images, the detection unit 20 outputs position information of the intruder to the processing unit 30. The processing unit 30 compares the received information with the content of the camera database stored in the storage unit 40. If the intruder remains in the monitored area “a,” camera A will continue to capture images and send the images to the detection unit 20. When the intruder enters one of the intersection ranges “ab” and/or “ac,” such as the intersection range “ab,” the processing unit 30 determines if the intruder will enter the monitored area “b” or remain in the monitored area “a.” The processing unit 30 searches the cameras A and B corresponding to the monitored areas “a” and “b” from the camera database, and controls the cameras A and B to capture the images of the monitored areas “a” and “b” and sends the images to the detection unit 20. If the intruder enters the intersection ranges “abc,” the processing unit 30 determines if the intruder will enter the monitored area “b” or the monitored area “c,” or remain in the monitored area “a.” The processing unit 30 searches the cameras A, B, and C from the camera database, and controls the cameras A, B, and C to capture the images of the monitored areas “abc” and sends the images to the detection unit 20. Therefore, the video monitoring system can continuously track the intruder.

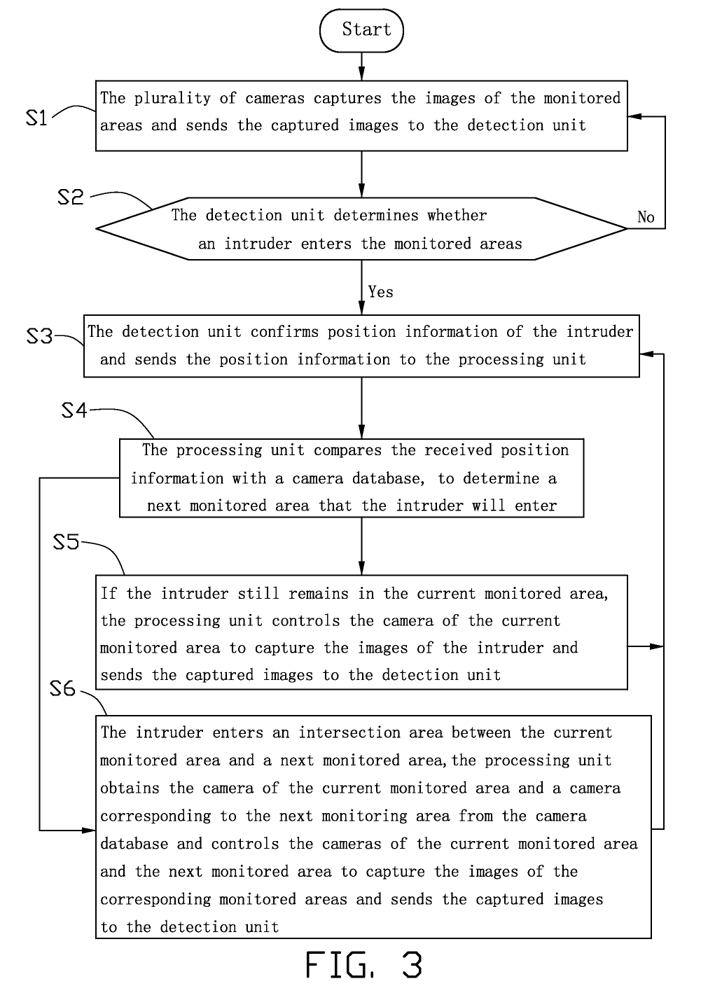

Referring to FIG. 3, an embodiment of a video monitoring method using the video monitoring system 1 in FIG. 1, includes the following steps.

In step S1, the plurality of cameras captures images of the plurality of monitored areas, and sends the captured images to the detection unit 20.

In step S2, the detection unit 20 determines whether an intruder enters one of the monitored areas according to the received images. If an intruder enters one of the monitored areas, the procedure goes to step S3. If the intruder does not enter one of the monitored areas, the procedure goes back to step S1.

In step S3, the detection unit 20 confirms the position information of the intruder and sends the position information to the processing unit 30.

In step S4, the processing unit 30 receives the position information of the intruder from the detection unit 20 and compares the received information with the content of the camera database stored in the storage unit 40, to determine a next monitored area that the intruder will enter. If the intruder remains in the current monitored area, the procedure goes to step S5. If the intruder enters an intersection area between the current monitored area and a next monitored area, the procedure goes to step S6.

In step S5, the processing unit 30 controls the camera of the current monitored area to continuously capture the images of the intruder and sends the images to the detection unit 20, and the procedure goes back to step S3.

In step S6, the processing unit 30 searches the camera of the current monitored area and a camera corresponding to the next monitored area from the camera database, and then controls the cameras of the current monitored area and the next monitored area to capture the images of the corresponding monitored areas and send the images to the detection unit 20. The procedure goes back to step S3.

The processing unit 30 compares the received information from the detection unit 20 with the content of the camera database stored in the storage unit 40, to determine a next monitored area that the intruder may enter. If the intruder is still located at the current monitored area, the processing unit 30 controls the camera of the current monitored area to continuously capture the images of the intruder and sends the images to the detection unit 20. If the intruder enters an intersection between the current monitored area and the next monitored area, the processing unit 30 uses the camera of the current monitored area and a camera corresponding to the next monitored area from the camera database, and controls the cameras of the current monitored area and the next monitored area to capture the images of the corresponding monitored areas and send the images to the detection unit 20. The video monitoring system can continuously track the intruder automatically and does not need manually switching the cameras for capturing images of the intruder.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the embodiments described therein.

What is claimed is:

1. A video monitoring system for monitoring an area, comprising:
a plurality of image capturing units to be disposed in a plurality of places of the monitored area, capturing a plurality of images of the plurality of places;
a detecting module examining each of the plurality of images to find a face of an intruder in the plurality of images, determining whether there is an intruder entering the monitored area, and confirming position information of a current place of the intruder according to the captured images when the intruder enters the monitored area;
a storage unit storing a camera database, the camera database comprising a plurality of parameters, the parameters comprising the camera of the current monitored area where the intruder enters, next monitored area the intruder will enter, and the camera corresponding to a next monitored area; and
a processing unit receiving the information of the intruder from the detection unit, comparing the received information with the content of the camera database stored in the storage unit, and determining a next place that the intruder will enter, wherein upon a condition that the intruder remains in the current place, the processing unit controls the camera of the current place to continuously capture the images of the intruder and sends the captured images to the detection unit; upon a condition that the intruder enters an intersection of the current place and the next place, the processing unit obtains the camera in the current place and a camera corresponding to the next place from the camera database, controls the cameras of the current place and the next place to capture the images of the corresponding places, and sends the images to the detection unit.

2. The video monitoring system of claim 1, wherein each image capture unit is a camera.

3. A video monitoring method comprising:
capturing images of monitored areas and sending the captured images to a detection unit;
determining whether there is an intruder entering one of the monitored areas according to the captured images, wherein upon a condition that no intruder enters one of the monitored areas, the procedure goes back to the step of capturing the images of the monitored areas and sending the captured images to the detection unit;
upon a condition that an intruder enters one of the monitored areas, confirming position information of a current place of the intruder entering, and sending the position information of the intruder to a processing unit;
providing a camera database comprising: the camera of the current monitored area where the intruder enters: next monitored areas the intruder will enter, and the camera corresponding to a next monitored area;
comparing the received position information of the intruder with the camera database, to determine a next monitored area that the intruder will enter;
upon a condition that the intruder remains in the current monitored area, controlling the camera of the current monitored area to continuously capture the images of the intruder and sending the images to the detection unit, and the procedure goes back to the step of confirming position information of a current place of the intruder entering and sending the position information of the intruder to a processing unit; and
obtaining cameras corresponding to the current monitored area and the next monitored area from the camera database and controlling the cameras of the current monitored area and the next monitored area to capture the images of the corresponding monitored areas and sending the images to the detection unit, upon a condition the intruder enters an intersection between the current monitored area and the next monitored area, and the procedure goes back to the step of confirming position information of a current place of the intruder entering and sending the position information of the intruder to a processing unit”.
